(19) United States
(12) Patent Application Publication
(10) Pub. No.: US 2008/0116625 A1
(43) Pub. Date: May 22, 2008

(54) Longitudinal Folding Device Comprising Formers Having Different Widths

(76) Inventors: Goetz Stein, Bolligen (CH); Noel McEvoy, Littigen (CH)

Correspondence Address: RATNERPRESTIA, P O BOX 980, VALLEY FORGE, PA, 19482-0980, US

(21) Appl. No.: 11/661,336

(22) PCT Filed: Jul. 6, 2005
(86) PCT No.: PCT/CH05/00384

§ 371 Date: Nov. 6, 2007

(30) Foreign Application Priority Data
Aug. 27, 2004 (DE) 10 2004 041.666.4

(51) Int. Cl. B41L 43/04

(52) U.S. Cl. 270/41

(57) ABSTRACT

A longitudinal folding device comprising a) a first former having a first width (b/2), b) and a second former having a second width (rb/2), c) the second width (rb/2) being greater than the first width (b/2) and smaller than twice the first width (b/2). Additionally, a printing press and a process for producing printed copies.

This application is the U.S. national phase application of PCT International Application No. PCT/CH2005/000384, filed Jul. 6, 2005, which claims priority to German Patent Application No. DE 10 2004 041 666.4, filed Aug. 27, 2004.

### BACKGROUND OF THE INVENTION

1. Technical Field

The present invention pertains to a longitudinal folding device for the longitudinal folding of webs or web strands, which is preferably intended for a printing press or is installed in a printing press. The webs and web strands are preferably paper webs. A printing press in which the longitudinal folding device is advantageously installed may be especially a rotary printing press, preferably a web-fed rotary printing press. Offset printing is preferred. Use in newspaper printing and in printing newspaper-like printed products is preferred in respect to the number of copies of the product or products to be produced with the longitudinal folding device.

2. Description of the Related Art

Efforts are continuously made in the design of printing presses to increase flexibility in respect to the format of the printed products that can be produced with a printing press. It is known to be possible, for example, from EP 0 557 774 B1, DE 101 63 209 B4 and U.S. Pat. No. 1,770,350 to use a plurality of formers that are adjustable in relation to one another in order to maintain the flexibility concerning longitudinal folding. The printing presses according to EP 0 557 774 B1 and EP 1 145 850 A1 have formers at different levels. EP 1 145 850 A1 and JP 61023078 describe, furthermore, the use of formers having different widths, a former of a double, second width being associated with two formers of a first width each. The formers according to EP 1 145 850 A1 form the intake for the web strands to be folded at the same level, while the web strands to be folded in the formers according to JP 61023078 enter at different levels, i.e., they run onto the respective former intake rollers associated with the formers.

### SUMMARY OF THE INVENTION

An embodiment of the present invention provides a longitudinal folding device that is flexible in respect to the longitudinal folding of webs having different widths and nevertheless permits a design with the smallest possible overall height.

An embodiment of the present invention pertains to a longitudinal folding device for the longitudinal folding of webs and/or web strands passing through, which is preferably installed in a printing press or is intended for installation. The longitudinal folding device comprises at least two formers, namely, at least one first former of a first width and at least one second former of another, second width. The formers may be arranged such that they fold one of the web strands each of a web that was previously cut lengthwise in the press. Furthermore, they may also be arranged or used such that they fold webs and/or web strands that pass separately through the press from the very beginning.

According to an embodiment of the present invention, the second width is greater than the first width and smaller than twice the first width. The widths of the two formers, always measured at the upward end, i.e., at the intake end, of the particular former, thus differ by a factor that is greater than one and smaller than two. The longitudinal folding device according to the present invention is especially suitable for the longitudinal folding of webs and web strands whose widths do not differ simply by an integer multiple. Compared to the prior-art longitudinal folding devices with formers of single width and double width, the longitudinal folding device according to the present invention can be designed with a smaller overall height. Namely, the double-width former of the prior-art devices also has twice the overall height of the single-width formers. As long as the web to be folded does not have the double width, i.e., it is narrower, overall height is wasted in the prior-art devices and depth, and, at any rate, on the whole, installation space is also wasted because of the sloped arrangement of formers. Furthermore, a web of a width between the single width and the double width would run unguided over a certain length over the former surface up to the folding edges of the former. This unguided section can be at least reduced by selecting a suitable intermediate dimension of the former width.

In preferred embodiments, the second width is at least 1.2 times and at most 1.7 times the first width, and even more preferably at least 1.3 times and at most 1.6 times the first width. In an especially preferred embodiment, the first width corresponds to half or one third of the maximum width of the web. If it corresponds to half of the maximum width of the web, the second width is, for example, two thirds of the maximum width of the web, which can correspond, for example to a first width of 27.5 in. and to a second width of 37 in. (US Commercial).

A deflecting means, which is arranged at the intake end of the respective former and deflects the arriving web onto the former, is associated with each of the formers. The deflecting means are preferably former intake rollers, i.e., rotatably mounted rotation bodies, which extend at least over the width of the associated former. Even though the deflecting means will hereinafter be called a former intake roller, other deflecting means, for example, deflecting rollers or a stationary deflecting surface, shall not be ruled out.

In a first embodiment, the first former and the second former are arranged vertically offset in relation to one another, in general, at right angles to the arriving web or the arriving web strand, in different planes. In a second embodiment, the at least two formers are arranged offset in relation to one another in the direction of delivery of the arriving web or of the arriving web strand only, i.e., horizontally. Finally, the formers are arranged offset in relation to one another both vertically and horizontally in a third embodiment.

In yet another, likewise preferred, fourth embodiment, the first former and the second former are arranged next to each other, preferably in an at least essentially flush arrangement at right angles to the direction of delivery of the web. A separate former intake roller each may be associated with the formers arranged next to each other, the deflecting axes of the former intake rollers preferably being flush. A single former roller may preferably also be associated with the formers such that it is shared by the latter, as a result of which it is possible, for example, to reduce the assembly effort.

The longitudinal folding device is preferably part of a web-fed rotary printing press, which may be especially a newspaper printing press. The printing press comprises printing cylinders, which preferably form a plurality of printing gaps for one or more web or webs passing through the printing cylinders, and printing form cylinders associated with the printing cylinders, for example, pairs of rubber blanket cylinders and plate cylinders. At least one of the printing form cylinders has one or more printing forms of one width, which is adapted to the first width, and at least one other printing form cylinder has one or more printing forms of another width, which is adapted to the second width. Only a single one of the printing form cylinders each may be associated with the printing cylinders forming the printing gap, or two or, in principle, even more printing form cylinders may also be associated with one each of the printing cylinders forming the printing gap, and the plurality of associated printing form cylinders per printing cylinder may also be engaged with the associated printing cylinders as desired in order to make it possible to change over from one print format to the other in a flexible manner.

Printed products, preferably newspaper copies and newspaper-like copies, for example, semi-commercials, which have longitudinally folded double sides of different widths, are produced in preferred print productions in such a press, where the different widths of the printed copies can correspond especially to the different widths of the formers exactly or with a dimension smaller than specified. Furthermore, it is possible to produce in the same press printed copies of different formats, i.e., up to the maximum widths predetermined by the formers, in which case the printed copies having different widths can be produced in the press in the same production simultaneously or sequentially in consecutive productions.

### BRIEF DESCRIPTION OF THE DRAWINGS

Exemplary embodiments of the present invention will be explained below on the basis of figures. Features disclosed in the exemplary embodiments advantageously develop the subjects of the claims and the above-described embodiments individually and in any combination of features. In the drawings,

FIGS. 1 and 2 show a front view and a side view, respectively, of a first exemplary embodiment of a longitudinal folding device.

FIGS. 3 and 4 show a front view and a side view, respectively, of a longitudinal folding device according to a second exemplary embodiment.

FIGS. 5 and 6 show a front view and a side view, respectively, of a longitudinal folding device according to a third exemplary embodiment.

FIGS. 7 and 8 show a front view and a side view, respectively, of a longitudinal folding device according to a fourth exemplary embodiment.

FIGS. 9 and 10 show a front view and a side view, respectively, of a longitudinal folding device according to a fifth exemplary embodiment.

### DETAILED DESCRIPTION

FIG. 1 shows a longitudinal folding device according to a first exemplary embodiment for a web-fed rotary printing press for newspaper offset printing and/or for printing newspaper-like printed copies. A front view against the direction of travel of the web is shown. The longitudinal folding device comprises two first formers 1 and a second former 2. The first two formers 1 are arranged next to each other in a first plane I and the second former 2 is arranged vertically offset above or optionally also horizontally in relation to the first formers 1, offset in a second plane II. A single former intake roller 3, which correspondingly extends over the entire width of the two formers 1, is associated with the first formers 1 together. A separate former intake roller 3 of its own is associated with the second former. A former tip, which is formed by each of the formers 1 and 2 and forms an outlet end of the respective formers 1 and 2, is designated by 4.

The formers 1 and 2 are mounted between side walls 5 of the press frame. The printing press is a four-side-wide printing press for printing on a web of the maximum width b with four sides next to one another. The first two formers 1 are of single width each with a first width b/2 each. They are therefore suitable for the longitudinal folding of a web of a maximum width b/2 or of a web strand of a corresponding width of a broader web of a greater width, which was, however, cut lengthwise in advance by means of the associated longitudinal cutting means 8. The second former 2 is arranged, either stationarily or preferably adjustably along its associated former intake roller 3, such that its former tip 4 comes to lie exactly in the middle of a web of the maximum width b. The first two formers 1 are arranged symmetrically on both sides of the center line of a web of the maximum width b.

At its intake end facing the associated former intake roller 3, the second former 2 has a width that is, on the one hand, smaller than twice the first width b/2, even though it is greater than the width b/2 of the first former 1. The width of the second former 2 is correspondingly rb/2, where r is a number greater than 1 and smaller than 2. Especially preferred values of r are in the range of 1.3 to 1.5.

The formers 1 and 2 form a former plane each, which is triangular in the front view shown in FIG. 1, with the greatest width b/2 and rb/2 at the intake end and practically of the width zero at the outlet end, i.e., at the respective former tip 4. The side edges of the respective former plane form folding edges 1a and 1b in the first former 1 and folding edges 2a and 2b in the former 2. The folding edges 1a through 2b converge in a straight line to the respective former tip 4 at an acute angle of twist β. The second former 2 has the same angle of twist β as the first former 1.

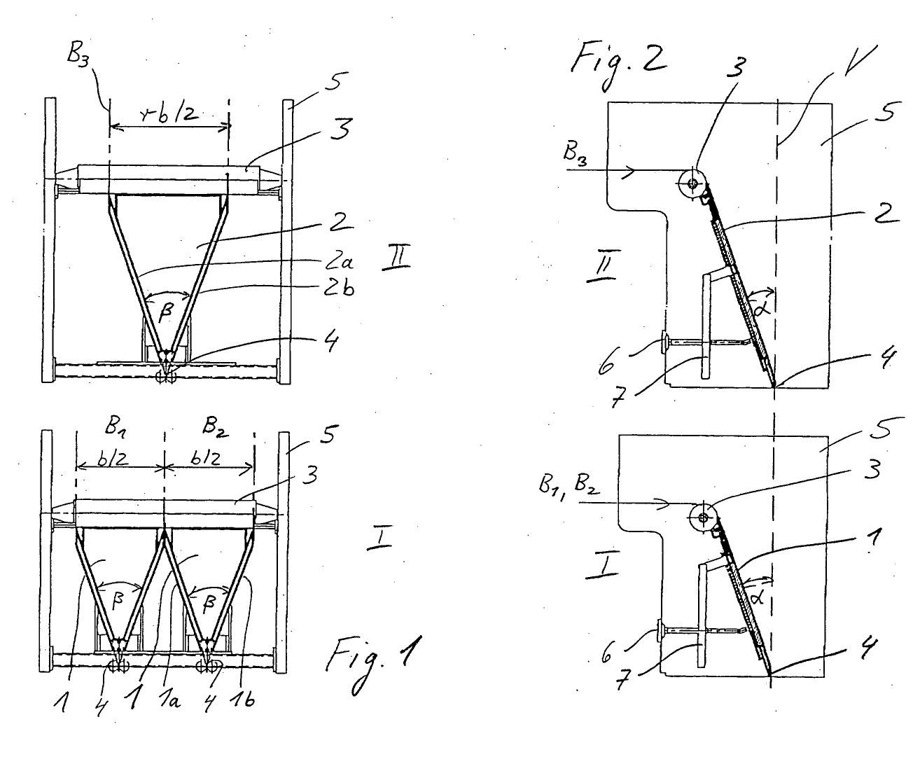

FIG. 2 shows a side view of the longitudinal folding device according to the first exemplary embodiment. The former planes of the formers 1 and 2 have the same slope toward the vertical lines V with the slope angle α that is constant over the entire length of the former. The slope, stated in slope angle α, and the angle of twist β are preset within narrow limits in folding technology, and, at the least, they cannot be varied as desired. Compared to a printing press having only formers of an equal width, the flexibility of the printing press in respect to the printed product formats that can be produced is markedly increased by means of the second former 2, which is designed with an intermediate dimension between the single-wide formers 1 and the double-wide formers known from the state of the art, while the longitudinal folding device can have a flatter design than longitudinal folding devices that have a double-wide former instead of the second former 2 designed according to the present invention.

Furthermore, FIG. 2 shows adjusting means 6, 7, by means of which each of the formers 1 and 2 can be adjusted linearly in the horizontal direction.

For example, two webs or web strands B₁ , and B₂, which were obtained before printing by longitudinal cutting from one web, and another web or web strand B₃ can be folded longitudinally with the longitudinal folding device according to the first exemplary embodiment. The webs and/or web strands are, in general, in the form of a bundle each before folding. The webs, web strands or bundles B₁ and B₂ guided over the first former 1 have at most a width b/2 each, and the web, the web strand or the bundle B₃ has at most the width rb/2 of the second former 2. The webs, web strands or bundles B₁, B₂ and B₃ are guided centrally onto the associated former 1 or 2. It is possible, in particular, by means of the second former 2 to fold webs, web strands and bundles B₃ that do not fit the usual formats. A web B₃ can be taken up centrally from a roll unwinder, which can advantageously also unwind rolls of the maximum width of the respective printing press, and guided straight onto the longitudinal folder 2 through the printing gap or printing gaps without turning and/or longitudinal cutting and/or spreading and folded longitudinally during its passage through the former 2. However, it is a condition that the second former 2 is arranged centrally in relation to the roll unwinder and that the web in question have at most double width. The flexibility can be further increased due to the adjustability of the second former 2 transversely to the direction of web feed.

In a typical print production, the web strands B₁ and B₂ are obtained from a printed web, which has, compared to the maximum width b, a dimension that is smaller than specified and is obtained from the spreading of the web strands. This double-wide printed web is unwound from a roll unwinder of the printing press and cut longitudinally into the web strands B₁ and B₂. The web strands B₁ and B₂ are spread by a certain amount of spread before printing, so that a distance corresponding to the amount of spread is obtained between them. The web strands B₁ and B₂ are then printed on in one color or in multiple colors on one side or on both sides. The web strands B₁ and B₂ are merged with additional web strands of an equal width each and folded longitudinally together or in a separate web strand bundle each by means of the first former 1. Simultaneously or in a later production, a printed web, which has a width greater than b/2 and at most rb/2, can be unwound from another roll unwinder, preferably centrally. The printed web B₃ is preferably printed on on one side or on two sides as well as in one color or in multiple colors without longitudinal cutting and without spreading and delivered preferably straight, i.e., without turning, over the second former 2 after printing and longitudinally folded as a result. Before the longitudinal folding, the web B₃ may be merged with additional webs having the same width and folded longitudinally in a bundle by means of the former 2. Simultaneously or in print productions offset in time, printed copies can be produced by means of the same printing press in different formats corresponding to the widths of the formers 1 and 2. As an alternative, the webs or web strands B₁ and B₂ as well as the web B₃, optionally in a bundle each, may be merged after the longitudinal folding in order to form printed copies together. For example, an additional sheet or bundle of additional sheets with an asymmetric longitudinal fold can thus be formed by means of the second former 2 and combined with the single-wide bundle or bundles. Furthermore, a correspondingly smaller insert can be obtained, for example, by means of the smaller former 1 for a larger format formed by means of the former 2.

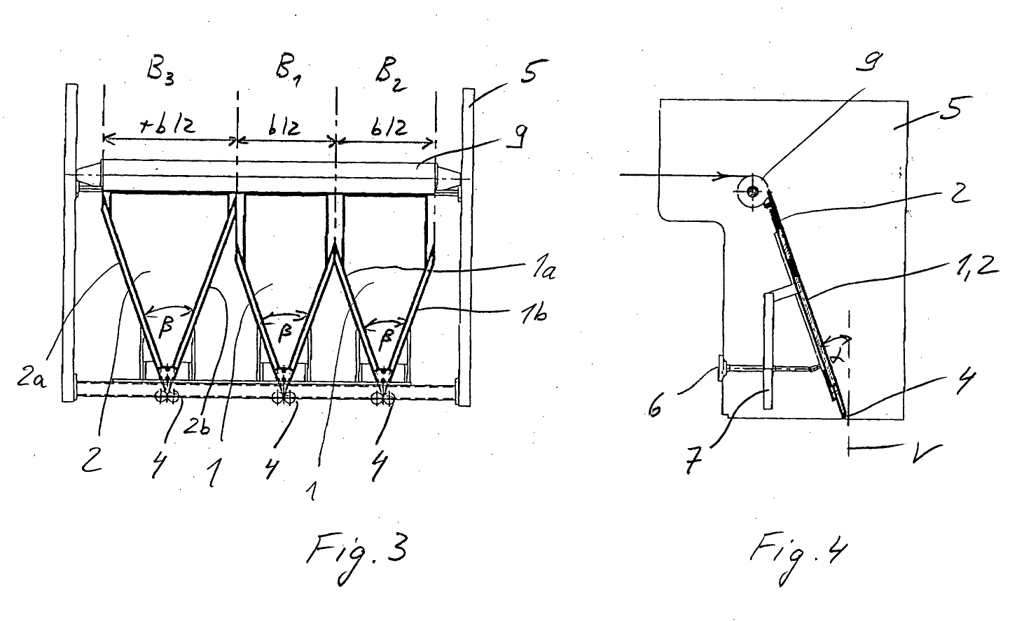

FIG. 3 shows a front view of a longitudinal folding device according to a second exemplary embodiment. FIG. 4 shows a side view of the longitudinal folding device according to the second exemplary embodiment. The longitudinal folding device according to the second exemplary embodiment likewise comprises the three formers 1 and 2. However, the first two formers 1 and the second former 2 are arranged directly next to one another in the same plane, the second former 2 being arranged next to the first two formers 1 on the outside rather than in between i.e., centrally. This arrangement is especially suitable for the longitudinal folding of three web strands B₁, B₂ and B₃, which were obtained from a printed web by asymmetric longitudinal cutting. The first two formers 1 have the same width b/2 again and the second former has the intermediate width rb/2 again.

A former intake roller 9 is associated with the formers 1 and 2 together. The former 2 joins the former intake roller 9 directly with its intake end, while the first two formers 1 are arranged downstream of the former intake roller 9 in the direction of the web to the extent that their respective former tip 4 is formed on the same horizontal line as the former tip 4 of the second former 2.

The longitudinal folding device according to the second exemplary embodiment otherwise corresponds to that according to the first exemplary embodiment.

It shall still be added concerning the widths of the formers 1 and 2 that the widths are measured in all exemplary embodiments and also in general between the ends of the respective folding edges la and lb, on the one hand, and 2a and 2b, on the other hand, which ends are spaced farthest apart from one another.

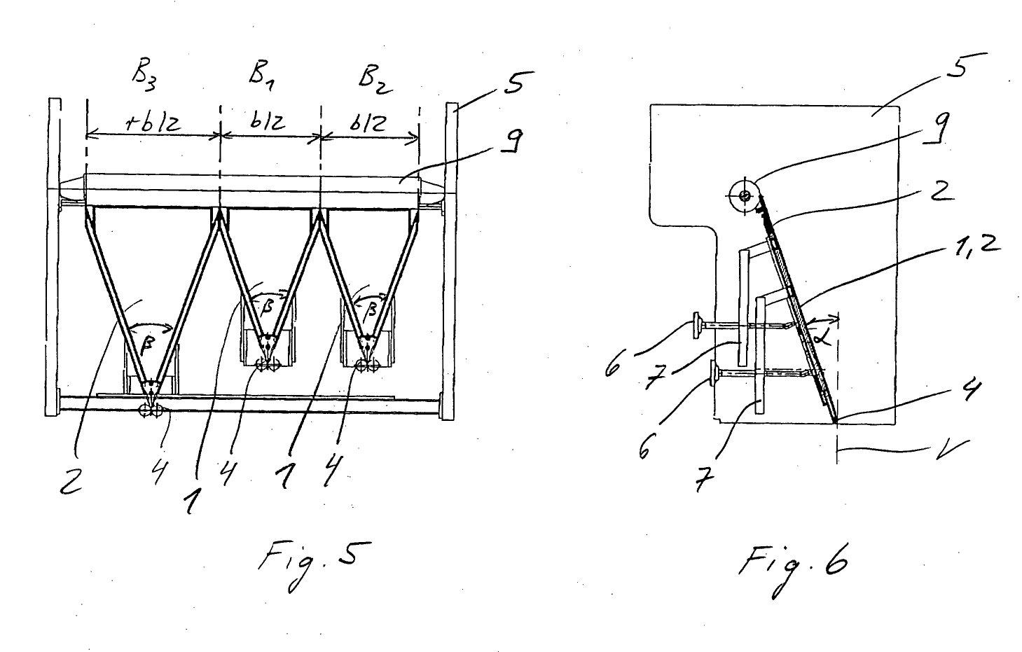

FIGS. 5 and 6 show a front view and a side view of a longitudinal folding device according to a third exemplary embodiment. Contrary to the second exemplary embodiment, the intake ends of the first formers 1 are arranged directly at the former intake roller 9, so that the web strands B₁ and B₂ run off from the former intake roller 9 and are at the same time folded longitudinally over the folding edges 1a and 1b of the formers 1. The respective former tip 4 of the formers 1 is correspondingly likewise moved closer to the former intake roller 9 and is no longer in the same horizontal plane as the former tip 4 of the second former 2. The longitudinal folding device according to the third exemplary embodiment otherwise corresponds to that according to the second exemplary embodiment.

For example, webs that have a width between five-side-wide webs and six-side-wide webs can be processed with the longitudinal folding devices according to the second and third exemplary embodiments, the width stated being related to five and six sides of equal width of a usual six-side-wide printing press. Webs that have an overall width of up to 2×b/2 +rb/2 before the longitudinal cutting can be processed without waste in the second and third exemplary embodiments.

However, the arrangements of the formers 1 and 2 according to the second and third exemplary embodiments are used primarily for the longitudinal folding of webs that are unwound from separate roll unwinders and are folded longitudinally in print productions carried out simultaneously or separately, offset in time. Thus, the longitudinal folding devices according to the second and third exemplary embodiments can especially also be installed for printing presses or in printing presses that can process four-side-wide webs as a maximum. In such embodiments, the longitudinal folding devices have an excess width compared to the respective printing press. What was said in connection with the first exemplary embodiment applies to the print productions, but it does so with the restriction that the web B₃ is made parallel by turning before the second former 2.

A plurality of consecutive webs and/or web strands are, in general, guided in a bundle and folded longitudinally together via the formers 1 and 2 according to all exemplary embodiments.

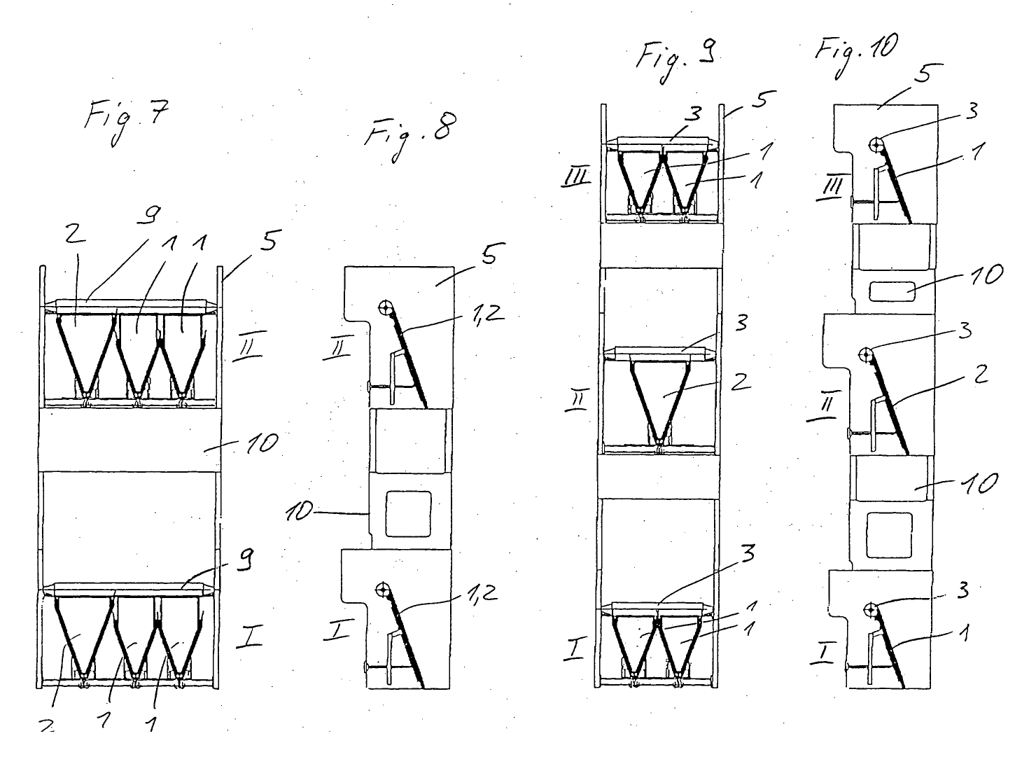

FIGS. 7 and 8 show a front view and a side view of a longitudinal folding device according to a fourth exemplary embodiment. The longitudinal folding device comprises two longitudinal folding devices according to the second exemplary embodiment, which are arranged between the side walls 5 of the press frame in two planes I and II one on top of another. A pulling means 10 for the upper longitudinal folding device is arranged between the two longitudinal folding devices.

FIGS. 9 and 10 show a front view and a side view of longitudinal folding device according to a fifth exemplary embodiment. The longitudinal folding device comprises a longitudinal folding device according to the first exemplary embodiment, i.e., two first formers 1 arranged in a plane I and a second former 2 arranged in a plane II above it, as well as once again two first formers 1, which are arranged next to one another but in another plane III above the second former 2 corresponding to the first exemplary embodiment. The longitudinal folding device comprises, furthermore, a lower pulling means 10 for the second former 2 and an upper pulling means 10 for the two upper, first formers 1. The pulling means 10 are arranged vertically between the second former 2 and the lower formers 1 as well as the second former 2 and the upper formers 1. Two-side-wide web strands of a double-wide web or even the web strands of narrower bands can be folded by means of the first formers 1, while the second former 2 can perform the central folding of a web of an intermediate width of up to a maximum of rb/2, for which turning operations as well as cutting and spreading operations are not necessary.

A longitudinal folding device according to the present invention may already comprise the arrangements according to the exemplary embodiments alone. In principle, the longitudinal folding device may also comprise only one first former 1 and a second former 2, which has an intermediate width according to the present invention in relation to the first former 1. Finally, the longitudinal folding devices according to the exemplary embodiments may also form only part of a longitudinal folding device of the printing press and be expanded by additional formers. For example, a plurality of second formers 2 may also be arranged next to each other. The arrangement of the only roll unwinder or of the preferably more than one roll unwinder, of the only or preferably more than one printing mechanism and of the longitudinal folding device of the printing press is preferably such that web paths lead from the roll unwinder or the roll unwinders both to the first former or the first formers and to the second former or second formers or, as is possible, for example, in the second, third and fourth exemplary embodiments, to the first and second formers or to the first and second formers together. The web being unwound can preferably be guided from the same roll unwinder of the printing press to one first former or, after longitudinal cutting, to a plurality of first formers in a first print production and another web can be guided to one second former or to a plurality of second formers in a second print production. Mixed productions are also possible, in principle, in which at least one first and one second former are provided for web strands of the same web, as it was explained, for example, on the basis of the second, third and fourth exemplary embodiments.

1. Longitudinal folding device, comprising:
a) a first former of a first width (b/2),
b) and a second former of a second width (rb/2),
c) wherein the second width (rb/2) is greater than the first width (b/2) and smaller than twice the first width (b/2).

2. Longitudinal folding device in accordance with claim 1, wherein the second width (rb/2) is at least 1.2 times and at most 1.7 times the first width (b/2).

3. Longitudinal folding device in accordance with claim 1, wherein the longitudinal folding device is configured for a web-processing machine, and the maximum width of a web that can be processed by means of the machine corresponds to the second width (rb/2), to an integer multiple of the second width (rb/2) or to an integer multiple of the first width (b/2).

4. Longitudinal folding device in accordance with claim 1, further comprising, a former intake roller for the first former and an additional former intake roller for the second former, the formers being arranged such that the former intake rollers are offset transversely in relation to one another.

5. Longitudinal folding device in accordance with claim 4, wherein the formers are offset vertically in relation to one another.

6. Longitudinal folding device in accordance with claim 4, wherein the formers are offset horizontally in relation to one another.

7. Longitudinal folding device in accordance with claim 1, wherein the first former and the second former are arranged next to each other.

8. Longitudinal folding device in accordance with claim 7, wherein a common former intake roller is associated with the formers.

9. Longitudinal folding device in accordance with claim 7, wherein folding edges of the first former and folding edges of the second former diverge at an angle at least essentially up to the same level.

10. Longitudinal folding device in accordance with claim 1, wherein folding edges of the first former and folding edges of the second former diverge at an angle at least essentially up to a former intake roller associated with the respective former.

11. Longitudinal folding device in accordance with claim 1, wherein at least two first formers are provided.

12. Longitudinal folding device in accordance with claim 1, wherein at least four first formers are provided.

13. Longitudinal folding device in accordance with claim 30, wherein the second former is arranged in yet another, third plane.

14. Longitudinal folding device in accordance with claim 30, wherein at least one second former each is also arranged in the first plane and in the second plane.

15. Longitudinal folding device in accordance with claim 1, wherein at least two second formers are provided.

16. Longitudinal folding device in accordance with claim 15, wherein the at least two second formers are arranged vertically offset in relation to one another.

17. Longitudinal folding device in accordance with claim 15, wherein the at least two second formers are arranged next to each other.

18. Longitudinal folding device in accordance with claim 1, wherein the first and second formers have essentially the same slope (α) relative to the vertical.

19. Longitudinal folding device in accordance with claim 1, wherein each of the formers has folding edges pointing towards each other at an angle and the folding edges of the first former and the folding edges of the second former form between them an angle of twist (β) that is at least essentially equal in the first and second formers.

20. Printing press comprising:
a) a roll unwinder,
b) printing cylinders, which form at least one printing gap for a web being unwound from the roll unwinder,
c) and a longitudinal folding device in accordance claim 1.

21. Printing press in accordance with claim 20, wherein the printing cylinders form a plurality of printing gaps and each of the printing cylinders is associated with at least one form cylinder and in that at least one of the form cylinders is provided with one or more printing forms for the first width and another of the form cylinders is provided with one or more printing forms for the second width.

22. Printing press in accordance with claim 21, wherein the form cylinders are provided with printing form receptacles for receiving the printing form of different widths, the printing form receptacles being of different widths according to the widths of the printing forms or variable in their respective width.

23. Process for producing printed copies on a web-fed rotary printing press, which has a longitudinal folding device in accordance with claim 1, the process comprising the steps:
a) unwinding, from a roll unwinder of the printing press, a first printed web of a first width or of a width equaling twice the first width and printing on at least on one side in at least one printing gap,
b) unwinding, from another roll unwinder of the printing press, a second printed web of a second width, which is greater than the first width and smaller than twice the first width, and printing on at least on one side in at least one other printing gap,
c) folding the first printed web longitudinally by means of a first former or web strands obtained from the first web by longitudinal cutting by means of a plurality of first formers.
d) folding the second printed web longitudinally by means of the second former,
e) cross-cutting and subsequently cross-folding the first web or the web strands obtained therefrom after the longitudinal folding and the longitudinally folded second web.

24. Process in accordance with claim 23, wherein the second printed web is delivered over the second former without cutting or spreading.

25. Process in accordance with claim 23, wherein the second printed web is unwound centrally from the roll unwinder.

26. Process in accordance with claim 23, wherein the second web is folded longitudinally with additional second webs of equal width by means of the second former and is further processed into a first printed copy and the longitudinally folded first web or the web strands obtained therefrom are folded longitudinally with additional webs folded longitudinally or respective web strands obtained therefrom by means of the first former or a plurality of first formers and processed further into another printed copy by means of cross-cutting and cross-folding.

27. Process in accordance with claim 23, wherein the first web or the web strands obtained therefrom after the longitudinal folding and the said, longitudinally folded second web are merged and further processed into a printed copy by means of cross-cutting and cross-folding.

28. Process for producing printed copies on a web-fed rotary printing press, which has a longitudinal folding device in accordance with claim 1, the process comprising the steps:
a) unwinding a printed web from a roll unwinder of the printing press and cutting the printed web longitudinally into at least two web strands, one of which has a first width or twice the first width and the other has a second width that is greater than the first width but smaller than twice the first width,
b) printing on at least one side of the web strands in at least one printing gap,
c) folding the web strands longitudinally by means of the longitudinal folding device, and
d) merging or cross-cutting, and subsequently cross-folding, the longitudinally folded web strands separately from one another.

29. Longitudinal folding device in accordance with claim 11, wherein the at least two first formers are arranged next to each other.

30. Longitudinal folding device in accordance with claim 12, wherein two of the at least four first formers are arranged next to each other in a first plane and at least two others of the first formers are arranged in another, second plane.
